(19) United States
(12) Patent Application Publication
(10) Pub. No.: US 2025/0363479 A1
(43) Pub. Date: Nov. 27, 2025

(54) Method of minting an NFT from a timed transactional QR code generator for a payment receipt

(71) Applicant: HD Networks, LLC, Stuart, FL (US)

(72) Inventor: David N. Warren, Stuart, FL (US)

(21) Appl. No.: 19/267,356

(22) Filed: Jul. 11, 2025

Related U.S. Application Data
(63) Continuation-in-part of application No. 18/367,307, filed on Sep. 12, 2023, now abandoned.

(51) Int. Cl. G06Q 20/32

(52) U.S. Cl. CPC G06Q 20/3276; G06Q 2220/00

(57) ABSTRACT

A method for minting Non-Fungible Tokens from a captured transactional QR code generator at a point of purchase for payment receipts within a timed allotment is disclosed. The generator provides an on-the-fly transactional QR code that contains details pertaining to a specific transaction at point of purchase. The QR code is accessible to the buyer to scan with their mobile device within a predetermined time period. The buyer's mobile device decodes the QR code to retrieve an embedded tokenized URL within a predetermined time period. The buyer's mobile device connects to the tokenized URL string and mints the receipt into an NFT that is stored on a blockchain ledger. This allows the user to access a digital form of the receipt and store the receipt for later review or retrieval.

### PRIORITY CLAIM

In accordance with 37 C.F.R. 1.76, a claim of priority is included in an Application Data filed concurrently herewith. Accordingly, the present invention claims priority as a Continuation-in-part of U.S. Patent Application No. 18/367,307, entitled “METHOD OF MINTING AN NET FROM A TRANSACTIONAL QR CODE GENERATOR FOR A PAYMENT RECEIPT”, filed Sep. 12, 2023. The contents of the above referenced application is incorporated herein by reference (in its entirety).

### FIELD OF THE INVENTION

This invention is directed to payment receipts and, in particular, to a point of purchase Quick Response Code Generator associated with a payment receipt that is converted to a Non-Fungible Token when captured by a mobile device within a timed allotment.

### BACKGROUND OF THE INVENTION

Payment receipts issued by a seller to a buyer are proof of purchase to show payment for goods and/or services received by the buyer. These receipts are most commonly in the form of paper receipts, but can also be provided as digital receipts in the form of an email and/or SMS text message.

A receipt is evidence that the buyer provided a specific payment amount, on a specific date, to a specific seller, for specific quantities of specific items, at specific pricing. A receipt documents the transaction between a buyer and a seller and includes critical information, such as the date and time of the purchase, the products or services purchased, the price, applicable taxes, and the like. In many cases, a receipt is needed to prove that a purchase was made and indicates who is the owner or in lawful possession of the purchased item.

Depending on the goods and services purchased by the buyer, some or all may be eligible for return to the seller for a refund provided the buyer is able to provide proof the goods and/or services were purchased from the buyer, and also provide proof of the purchase price paid by the buyer to the seller for the various goods and/or services that the buyer intends to return. The seller relies on the buyer to maintain the payment receipt from the purchase and present it to the seller at the time of request for refund. The seller can validate the authenticity of the receipt, as well as the purchased items, quantities, purchase price, and date and time of transaction, along with the payment method used by the buyer.

Buyers often hold onto receipts as payment/expense proof for tax write-offs, or use payment receipts when submitting reimbursement requests from a third party. Warranty claims and insurance claims often rely on proper purchase documentation in the form of payment receipts.

Most paper receipts issued by sellers are on thermal paper. These thermal paper receipts are prone to fading, tearing, loss, fire, and water damage, such as from condensation of refrigerated items, rain, or the accidental drink spill. It is not uncommon for a receipt printer to be out of paper. This results in the buyer not receiving a payment receipt for the transaction at the location the payment was processed. It also imposes hardship on the buyer, requiring a receipt to go to a different payment terminal, which most buyers are not willing to wait for.

Quick Response Codes, or “QR Codes” are an array of black and white squares that, when scanned with a smartphone's camera, reveal various information. QR codes are commonly used for advertising and can provide a simple way to access an internet website without having to manually type or enter the URL. QR codes are unique in that the content of the embedded data formulates the array of black and white squares. QR codes can also be used to automatically configure applications where the configuration details are embedded in the black and white array of squares in the QR code.

Payment processing terminals are used as a quick means for a buyer to submit payment to a seller. Credit card terminals are an example of a payment processing terminal. Contactless payment terminals are another example of payment processing terminals. Some payment processing terminals may have small monochrome digital displays, while others may have larger color displays. These displays are helpful for the buyer to confirm payment amount, as well as provide confirmation of successful payment. Some common locations where payment processing terminals are located are: on fuel pumps (dispensers) at gas stations, grocery store check-out lines, convenience store check-out counters, retail store check-out counters, and restaurants. Retailers may refer to the location of the payment processing terminal as the “Point of Purchase” or POP. Some payment processing terminals may be connected to a Point-of-Sale Terminal. There are many more locations where payment processing terminals can be found, the above being just a short list provided as an example of common locations.

Receipt printers are used to provide proof of payment and are connected to the Point-of Sale or Payment Processing Terminal at each POP. Some sellers offer the buyer the ability to receive an emailed copy of the receipt. This allows for the proof of transaction and payment to be emailed by the seller to the buyer.

Among the many problems with printed receipts is that they are susceptible to fading, loss, and damage. Printed receipts are not environmentally friendly and can easily become litter. Printed receipts are inefficient, as often the receipt printer may be out of paper. Printed receipts take time to print out. The more items purchased, the longer the receipt and printing time. Printed receipts are often hard to read, even before fading occurs.

Emailed receipts have disadvantages as well. Emails can accidentally end up in a “junk” folder in the buyer's email rather than their inbox. They can also accidentally be deleted. Some email security programs block attachments and emails that contain sensitive information, such as payment details. If a buyer does receive a payment receipt via email, it is up to the buyer to store the emailed receipt. Organizing and storing emailed receipts can become time consuming and burdensome.

Non-Fungible Tokens, or “NFTs”, are digital certificates of ownership that “live” on a blockchain. Certificates get stored on the blockchain, which form a secure, permanent record that cannot be tampered with. Minting an NFT is the process of publishing the NFT on the blockchain. Among the many benefits of minting an NFT is the ability to track the authenticity of the item, such as who has owned it and who made it.

If a customer purchases an item from a retailer, the purchase will include a paper receipt from the retailer. Attempts have been made to email the receipt to the customer, but those digital receipts have never gained traction. Thus, the customer is left with either unsorted emailed receipts, PDF copies of a receipt, or a cluster of paper receipt that represent transactions that occurred. What is needed in the art is a QR code generator associated with the payment transaction for capture by a customer's mobile device within a timed allotment that then converts the receipt into an NFT. Having an NET as a receipt will provide a traceable receipt which may include important information, such as date, time, item(s), payment method, serial numbers, delivery tracking, warranty, information, etc, thereby allowing a customer to automate their record keeping.

### SUMMARY OF THE INVENTION

Disclosed is a method for minting Non-Fungible Tokens (NFTs) from a captured transactional QR code generator at a POP (point of purchase) for payment receipts within a timed allotment. The generator at the POP provides an on-the-fly transactional QR code embedded with a tokenized URL that contains details pertaining to a specific transaction. The transactional QR code is time allotted to appear on the POP and expires within a predetermined amount of time. The transactional QR code that appears on the POP would be easily accessible to the buyer to capture with their mobile device. Once the buyer captures the transactional QR code with their mobile device, the buyer's mobile device decodes the QR code to retrieve the embedded tokenized URL. The embedded tokenized URL must be retrieved by the buyer's mobile device within a predetermined time period, clicks on the link, or event occurs otherwise the embedded tokenized URL expires. The buyer's mobile device connects to the tokenized URL string with access to a digital receipt and then mints the digital receipt into an NFT that is stored on a blockchain ledger. This allows the user to access the digital form of the receipt and store the receipt for later review or retrieval.

An objective of the invention is to provide a transactional QR code generator and displays the transactional QR code at the point of purchase. The QR code being time allotted on the POP so as to expire in a predetermined amount of time.

Another objective of the invention is to provide a buyer the ability to scan the QR code with their mobile device to obtain a digital receipt.

Another objective of the invention is to provide the buyer the ability to scan the QR code with their mobile device to obtain a digital receipt from an online transaction. The QR code can be sent to the confirmed email address of the buyer or on the payment confirmation page after an online transaction.

Yet another objective of the invention is to provide a tokenized URL that limits the time period that the embedded URL in the QR code can be accessed. The embedded tokenized URL would expire in predetermined amount of time if not retrieved and accessed by the buyer's mobile device. Similarly, the embedded tokenized URL would expire in predetermined number of click on the URL or after specific event has occurred.

It is still yet another objective of the invention to provide timed expirations of the QR code and the embedded tokenized URL to provide a level of protection against possible theft of the receipt or fraud by a third party.

It is still another objective of the invention to provide expiration of the QR code after a predetermined number of attempts to capture and access the URL from the QR code by a mobile device; for instance after one attempt to capture the QR code it will expire.

Yet still another objective of the invention is to provide a transactional QR code generator associated with a payment receipt; the QR code being embedded with a tokenized URL with timed allotments, the payment receipt providing details for a specific transaction (like a gas station transaction), such as, but not limited to, gas price per gallon, total gallons purchased, purchase total, fuel amount total, station location, date, time, or any other type of relevant data.

Still yet another objective of the invention is to provide the QR code which is captured by the customer's mobile device within a predetermined time period before expiring and then the mobile device decodes the QR code to retrieve the embedded tokenized URL. Capturing the QR code and retrieving the embedded tokenized URL gives access to a digital form of a receipt, as a replacement for a paper receipt, which would lessen or eliminate the need for paper receipts and the associated costs for a printer, and ongoing purchasing of ink, paper, and/or thermal paper.

Another objective of the invention is for the customer's mobile device to retrieve the embedded tokenized URL, connect to a tokenized URL string in a predetermined time period, and mint the receipt into a Non-Fungible Token (NFT) that is stored on a blockchain ledger. Having a digitized form of a receipt on a blockchain ledger would provide a direct link to the transaction receipt with details, as well as automating the customer's record keeping within the blockchain.

Yet another objective of the invention is for the digital receipt and the subsequently converted NFT to also provide warranty details such as but not limited to manufacture warranties, extended warranties, or third party warranties.

It is another objective of the invention for the transactional details on the NFT include graphical representations. The graphical representations are provided as still or animated images via a GIF file or the like. For instance, the buyer can access the NET associated with a specific a gas station transaction and access the line item details or image details of the transactions, such as gas price per gallon, total gallons purchased, purchase total, fuel amount total, station location, date, time, or any other type of relevant data.

Other objectives and advantages of this invention will become apparent from the following description taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE DRAWINGS

FIG. 1 is a flowchart of accessing a digitized receipt from a captured transactional QR code generator at a point of purchase for payment receipts;

FIG. 2 is a flowchart of minting and storing Non-Fungible Tokens from a captured transactional QR code generator at a point of purchase for payment receipts; and

FIG. 3 is a pictorial representation of the present invention.

### DETAILED DESCRIPTION OF THE PREFERRED EMBODIMENT

A detailed embodiment of the instant invention is disclosed herein; however, it is to be understood that the disclosed embodiments are merely exemplary of the invention, which may be embodied in various forms. Therefore, specific functional details and examples of use disclosed herein are not to be interpreted as limiting, but merely as a basis for the claims and as a representation basis for teaching one skilled in the art to variously employ the present invention in virtually any electronic payment receipt.

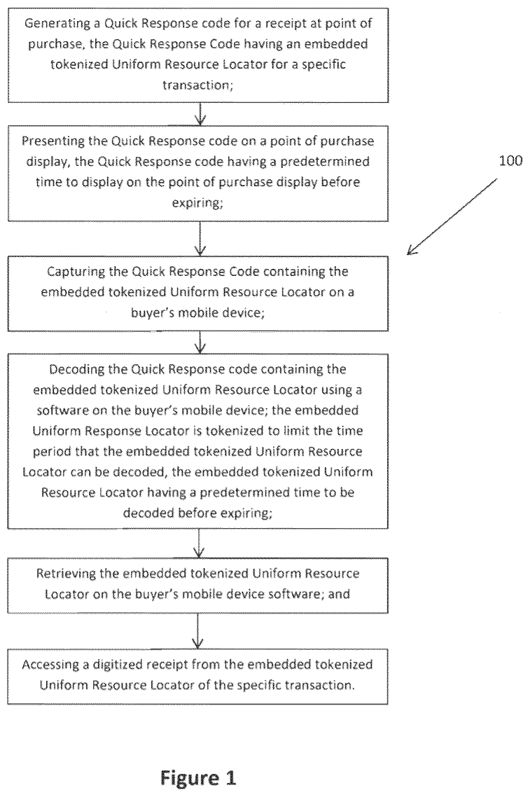

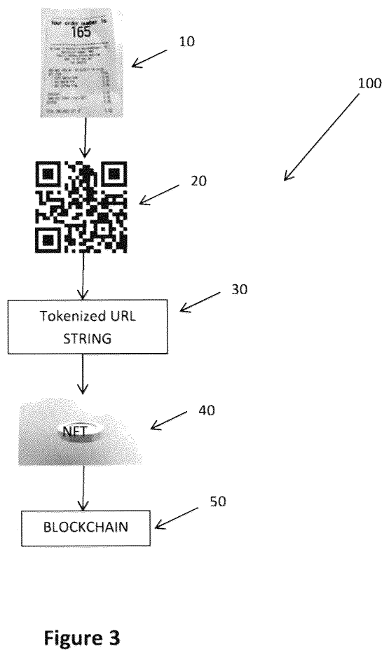

As shown in the FIGS. 1-3, the method 1700 for minting Non-Fungible Tokens from a captured transactional QR code generator at a POP (point of purchase) for payment receipts is disclosed. The generator provides an on-the-fly transactional QR code 20 embedded with a tokenized embedded URL 30 that contains details pertaining to a specific transaction, a receipt 10. The transactional QR Code 20 would be displayed on a POP display device that would be easily accessible to the buyer to capture with their mobile device. The transactional QR would have an allotted time period that is predetermined to be displayed on the POP display device before expiring. Limiting the time that the transactional QR code remains on a POP screen would prevent a third party from accessing the QR code and therefore mitigate theft or fraud. It is further contemplated as another level of protection against fraud that expiration of the QR code can occur after a predetermined number of attempts to capture and access the URL on the QR code by a mobile device; for instance after one attempt to capture the QR code it will expire.

Next, the buyer's mobile device decodes the QR code 20 to retrieve the embedded tokenized URL 30. The embedded tokenized URL also contains a predetermined time period in which the URL expires if it is not retrieved and accessed by the buyer's mobile device. The allotted time period creates another level of security for the buyer so as to prevent a third party from perpetrating fraud by accessing the URL. Additionally, the embedded tokenize URL can expire after a specific number of clicks on the URL or after a certain event. This is different from a standard URL, which is generally valid for as long as the underlying website or content remains accessible.

The buyer's mobile device then connects to the tokenized URL string 30 and mints the receipt 10 into an NFT 40 that is stored on a blockchain ledger 50. This allows the user to access a digital form of the receipt and store the receipt for later review or retrieval.

A receipt 10 is evidence that the buyer provided a specific payment amount, on a specific date, to a specific seller, for specific quantities of specific items, at specific pricing. A receipt 10 documents the transaction between a buyer and a seller and includes critical information, such as the date and time of the purchase, the products or services purchased, the price, applicable taxes, warranty and the like. Receipts 10 issued by a seller to a buyer are proof of purchase to show payment for goods and/or services received by the buyer. Receipts are also proof of warranty details such manufacture warranties, extended warranties, or 3rd party warranties. Once the receipt is converted into an NFT all the transactional details associated with the receipt and the specific transaction would appear on the NET as a line item or animated item, such a GIF file. The receipt is provided at a point of purchase, “POP”, an on-the-fly generated Transactional QR Code 20 that contains details pertaining to a specific transaction.

It is contemplated that the QR Code 20 is displayed on a display device at the point of purchase by the seller. Point-of-Sale terminals and payment processing terminals that have display capabilities may already be able to accommodate displaying a QR Code 20 through software and programming, while other point-of-sale and payment processing terminals may require a digital display output device with a display screen large enough to properly display a QR Code 20. It is further contemplated that QR code can be displayed from an online transaction. Upon completion of an online transaction the QR code can be sent to the confirmed email address of the buyer or the QR code can be displayed on the payment confirmation page after finalization of an online transaction. The QR Code 20 would be easily accessible to the buyer to scan with their mobile device. The buyer can scan the QR code 20 so that the receipt 10 can later be accessed in the form of an NFT 40 on a blockchain ledger 50. It is contemplated that the QR code 20 is set to expire within a predetermined amount of time. It is further contemplated that the QR code 20 having an embedded URL 30 that is tokenized so that it expires within a predetermined amount of time, a set number of clicks on the URL, or a specific event occurs. If the QR code or URL is not captured, accessed, and retrieved by the mobile device it expires and cannot be accessed again. This two stage level of expiring protection to provide security to the buyer that a third party will not access the QR code or the embedded tokenized URL. Furthermore, expiration of the QR code can occur after a predetermined number of attempts to capture and access the URL on the QR code by a mobile device; for instance after one attempt to capture the QR code it will expire.

QR Codes 20 are limited to 300 alphanumeric characters. Transactions with a limited number of line items and short descriptions may be able to have a QR Code 20 with the full receipt 10 embedded in the array of black and white squares, provided the total amount of alphanumeric characters does not exceed 300. When a transaction takes place, the seller will auto generate a QR Code for the transaction, which will be available on a display terminal for the seller to scan with their mobile device (smart phone, tablet, IoT Device). The QR Code will contain a two-dimensional barcode that will contain information about the transaction and may be read by a QR code reader. However, the QR code is time-sensitive and will only display on the POP display device a predetermined amount of time before expiring.

The QR Code 20 would be generated on-the-fly and would contain a unique hyperlink embedded in the array of black and white squares of the QR Code 20. The QR code 20 contains an embedded tokenized URL 30 for the specific transaction, receipt 10. This tokenized URL 30, when scanned, would access software in the mobile device that decodes and connects the URL string 30. The tokenized URL would also be time-sensitive for a predetermined amount of time, set number of clicks or specific event before expiring. A tokenized embedded URL that expires, also known as a temporary or expiring URL, is a URL that becomes invalid after a set period of time, a specific number of clicks, or after a certain event occurs. This is different from a standard URL, which is generally valid for as long as the underlying website or content remains accessible.

Mobile devices are equipped to decode a QR code 20; the mobile device uses its camera as its QR code scanning software. The mobile device camera detects the QR code 20 and identifies the QR code's position, size, and orientation. The software then looks for the pattern of black and white squares that make up the QR code 20 using a process called edge detection. Once the pattern of the QR code 20 is identified, the software decodes and connects to the embedded tokenized URL 30 within the QR code 20. This information can be any type of data. The software may display the information on the mobile device's screen, or it may take a specific action, such as connecting to the embedded tokenized URL string 30. It is contemplated that once the QR code 20 is captured the QR code 20 information can be stored in memory in various ways. For instance, the information can be stored as a string variable, stored on a database, stored in a file as either a text file or as an image file, or stored in an object or data structure, such as a list.

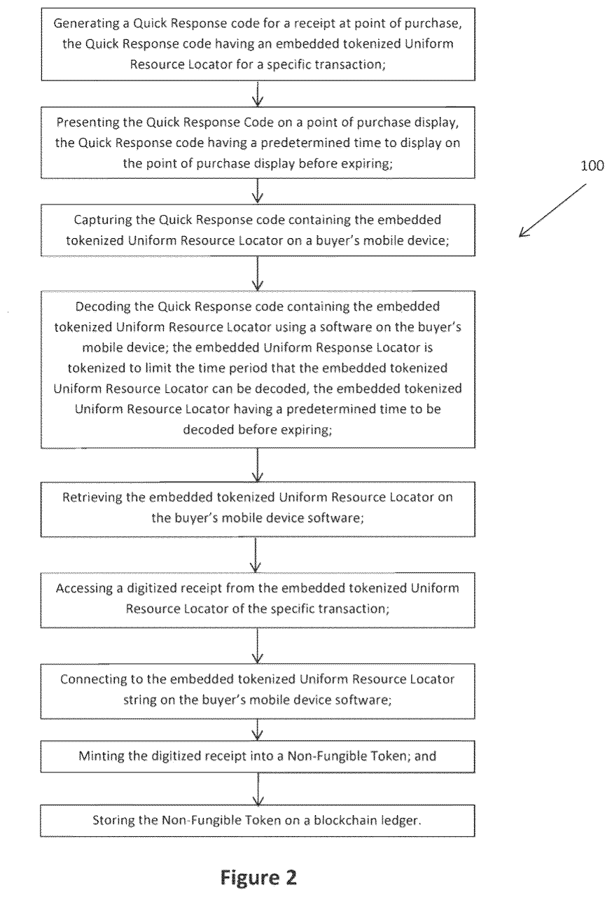

As shown in FIGS. 1 and 2, the method 100 of accessing a digitized receipt from a captured transactional QR code generator at a point of purchase for payment receipts is disclosed. As an exemplary example, the method would occur at a gas station pump POP display device. A user would purchase gas using any payment method and pump gas. To finalize the transaction, the POP display device would ask the user if they would like a receipt for their transaction. If the user chooses to have a receipt the method described would begin. The method includes the steps of having a generator provide an on-the-fly transactional QR code 20 embedded with a tokenized URL 30 that contains details pertaining to a specific transaction, a receipt 10. The transactional QR Code 20 would be presented on the POP display device and easily accessible to the buyer to capture with their mobile device. The QR code having a predetermined time to display on the point of purchase display before expiring. Additionally, a predetermined number of attempts to capture the QR code by the buyer's mobile device can expire the QR code. Once the QR code is expired access to capture the QR code and access to the embedded tokenized URL is finalized.

The buyer's mobile device includes software to decode the QR code 20 to retrieve the embedded tokenized URL 30 and then access a digitized receipt from the embedded tokenized URL 30 of the specific transaction. The embedded tokenized Uniform Resource Locator would have a predetermined time to be decoded, a predetermined number of clicks to the link, or specific event occurs before expiring. Thus a two stage level of expiring protection is provided for security purposes to the buyer so that a third party will not access the QR code or the embedded tokenized URL. Timed expirations of the QR code and the embedded tokenized URL provide a level of protection against possible theft of a receipt or fraud by a third party.

The digitized receipt includes transaction details that cannot be altered or changed. As shown in FIG. 2, the method 100 further includes the step of connecting to the embedded tokenized URL string in the buyer's mobile device software before accessing the digitized receipt from the embedded tokenized URL of the specific transaction. A digitized receipt provides a traceable form of a receipt which may include important information, such as date, time, item(s), payment method, serial numbers, delivery tracking, warranty etc., and thereby allow the buyer to automate their record keeping.

Once the software has decoded and connected to the embedded tokenized URL string 30, the process of minting the receipt into a Non-Fungible Token 40, “NFT”, begins. A digital file of the receipt is created within the software that then is converted into crypto collections or digital assets and recorded within a blockchain 50. Including an NFT 40 as a digitized receipt 10 will provide a traceable and private link that includes important information, such as specific payment amount, on a specific date, to a specific seller, for specific quantities of specific items, at specific pricing, date and time of the purchase, the products or services purchased, the price, applicable taxes, serial numbers, delivery tracking, warranties and the like. Furthermore, the receipt transaction details cannot be altered or changed on the blockchain ledger 50, Additionally, the buyer can automate their record keeping regarding exactly what has been purchased without having physical paper copies of the receipts 10. It would also be possible to display the full receipt details when one clicks into an item in a transaction history on the blockchain ledger 50.

The digitized NFT on the blockchain ledger will include transaction details that can be displayed as a line item or graphical representations. The graphical representations can be animated items in a Gif file format. For instance, if the NFT owner purchases a vehicle, the NFT digitized receipt would include a vehicle representation of the vehicle that allows the NFT owner to click on the vehicle tire and access details such as tire size, tire tread, brand, tire safety info, rim size, rim details, or the like. The same details can be provided in a line item format on the NET receipt.

When the receipt NFT 40 is minted on the blockchain 50, it carries unique metadata (hash signatures) that solely belongs to that NFT 40, the NFT issuer, being any institution or organization that can mint NET certificates, which can be verified by any party seamlessly. Digital non-fungible assets are easier to verify using smart contracts, reducing processes that may have taken weeks and months to mere seconds. The ownership and authenticity can be verified by simply comparing the generated hash signature on the document to that of the NFT 40.

In an alternative embodiment, a method for minting Non-Fungible Tokens (NFTs) from a captured transactional QR code generator at a POP (point of purchase) for payment receipts that includes warranty details. The method provides a QR Code within a timed allotment having an embedded URL that becomes invalid after a set period of time, a specific number of clicks, or after a certain event occurs, The seller can include warranty details in the digitized receipt on the NFT as a standard line item detail or as an add-on image. For example, the seller can choose to provide some of the transactional details as a still or animated image as a purchasable add-on feature to the NFT. If buyer selects to purchase the image or images as part of the NET, they will have the option to do with within the software application that supports the NFT. Seller may also offer photos of the buyer with their new purchase (i.e. as a keepsake memory) and include that as an image available to the buyer to be included in the NFT. Warranty details can include contact information, start and end dates, recalls, and options to extend.

Additionally, the seller can create the NFT as well. This would allow the seller to create additional sales opportunities by offering the buyer the option to have an NFT created for them by the seller. A seller created NFT of the bill of sale would be able to provide a more customized and interactive NFT. It would also allow for the seller to charge maintenance fees for the NFT.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements, possesses those one or more steps or elements, but is not limited to possessing only those one or more elements. Likewise, a step of a method or an element of a device that “comprises,” “has,” “includes” or “contains” one or more features, possesses those one or more features, but is not limited to possessing only those one or more features. Furthermore, a device or structure that is configured in a certain way is configured in at least that way, but may also be configured in ways that are not listed.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A method of minting a Non-Fungible Token from a transactional Quick Response code generator for a payment receipt in a timed allotment comprising the steps of:
generating a Quick Response code for a receipt at point of purchase, the Quick Response Code having an embedded tokenized Uniform Resource Locator for a specific transaction;
presenting the Quick Response code on a point of purchase display, the Quick Response code having a predetermined time to display on the point of purchase display before expiring;
capturing the Quick Response Code containing the embedded tokenized Uniform Resource Locator on a buyer's mobile device;
decoding the Quick Response code containing the embedded tokenized Uniform Resource Locator using a software on the buyer's mobile device; the embedded Uniform Response Locator is tokenized to limit the time period that the embedded tokenized Uniform Resource Locator can be decoded, the embedded tokenized Uniform Resource Locator having a predetermined time to be decoded before expiring;
retrieving the embedded tokenized Uniform Resource Locator on the buyer's mobile device software; and
accessing a digitized receipt from the embedded tokenized Uniform Resource Locator of the specific transaction.

2. The method of minting a Non-Fungible Token from a transactional Quick Response code generator for a payment receipt of claim 1, including connecting to the embedded tokenized Uniform Resource Locator string on the buyer's mobile device software.

3. The method of minting a Non-Fungible Token from a transactional Quick Response code generator for a payment receipt of claim 2, further including minting the digitized receipt into a Non-Fungible Token.

4. The method of minting a Non-Fungible Token from a transactional Quick Response code generator for a payment receipt of claim 3, further including storing the Non-Fungible Token on a blockchain ledger.

5. The method of minting a Non-Fungible Token from a transactional Quick Response code generator for a payment receipt of claim 4, wherein a seller generates the Quick Response code for a receipt at point of purchase for minting into the Non-Fungible Token.

6. The method of minting a Non-Fungible Token from a of claim 1, wherein the digitized receipt includes transaction details.

7. The method of minting a Non-Fungible Token from a transactional Quick Response code generator for a payment receipt of claim 5, wherein transaction details on the digitized receipt cannot be altered or changed.

8. The method of minting a Non-Fungible Token from a transactional Quick Response code generator for a payment receipt of claim 5, wherein the digital receipt includes line item details or image details.

9. The method of minting a Non-Fungible Token from a transactional Quick Response code generator for a payment receipt of claim 1, including retrieving and accessing the digitized receipt on the blockchain ledger.

10. The method of minting a Non-Fungible Token from a transactional Quick Response code generator for a payment receipt of claim 1, including viewing all digitized receipts on the blockchain ledger.

11. The method of minting a Non-Fungible Token from a of claim 1, allowing a predetermined attempt of capturing the QR code with a buyers mobile device before expiring.

12. A method of minting a Non-Fungible Token from a transactional Quick Response code generator for a payment receipt in a timed allotment comprising the steps of:
generating a Quick Response code for a receipt at point of purchase, the Quick Response code having an embedded tokenized Uniform Resource Locator for a specific transaction;
presenting the Quick Response Code on a point of purchase display, the Quick Response code having a predetermined time to display on the point of purchase display before expiring;
capturing the Quick Response code containing the embedded tokenized Uniform Resource Locator on a buyer's mobile device;
decoding the Quick Response code containing the embedded tokenized Uniform Resource Locator using a software on the buyer's mobile device; the embedded Uniform Response Locator is tokenized to limit the time period that the embedded tokenized Uniform Resource Locator can be decoded, the embedded tokenized Uniform Resource Locator having a predetermined time to be decoded before expiring;
retrieving the embedded tokenized Uniform Resource Locator on the buyer's mobile device software;
accessing a digitized receipt from the embedded tokenized Uniform Resource Locator of the specific transaction;
connecting to the embedded tokenized Uniform Resource Locator string on the buyer's mobile device software;
minting the digitized receipt into a Non-Fungible Token; and
storing the Non-Fungible Token on a blockchain ledger.

13. The method of minting a Non-Fungible Token from a transactional Quick Response code generator for a payment receipt of claim 11, wherein the digitized receipt includes transaction details.

14. The method of minting a Non-Fungible Token from a transactional Quick Response code generator for a payment receipt of claim 12, wherein transaction details on the digitized receipt cannot be altered or changed.

15. The method of minting a Non-Fungible Token from a transactional Quick Response code generator for a payment receipt of claim 11, including retrieving and accessing the digitized receipt on the blockchain ledger.

16. The method of minting a Non-Fungible Token from a of claim 12, including viewing all digitized receipts on the blockchain ledger.

17. The method of minting a Non-Fungible Token from a transactional Quick Response code generator for a payment receipt of claim 12, allowing a predetermined attempts of capturing the QR code with a buyer's mobile device before expiring.
